(19) United States
(12) Patent Application Publication
(10) Pub. No.: US 2019/0157649 A1
(43) Pub. Date: May 23, 2019

(54) Bus Bar Module and Wire Harness

(71) Applicant: Yazaki Corporation, Tokyo (JP)

(72) Inventor: Takeshi Oshima, Susono-shi (JP)

(73) Assignee: Yazaki Corporation, Tokyo (JP)

(21) Appl. No.: 16/191,825

(22) Filed: Nov. 15, 2018

(30) Foreign Application Priority Data
Nov. 17, 2017 (JP) 2017-221502

(51) Int. Cl. H01M 2/20; H01B 7/08; H01M 2/10; H01M 2/02

(52) U.S. Cl. CPC H01M 2/202; H01M 2/0277; H01M 2/1083; H01B 7/08

(57) ABSTRACT

A bus bar module includes a flat cable having a cable part and an insulator resin part and a bus bar crimped and fixed to the insulator resin part. The cable part includes a plurality of conductor wires arranged in parallel at predetermined intervals on a plane and a covering part integrally covering the plurality of conductor wires with an insulating resin. The insulator resin part is disposed in parallel to the cable part on the plane and made of a same resin as the insulating resin of the covering part.

### CROSS REFERENCE TO RELATED APPLICATIONS

This application claims priority from Japanese Patent Application No. 2017-221502 filed on Nov. 17, 2017, the entire contents of which are incorporated herein by reference.

### BACKGROUND OF THE INVENTION

### Field of the Invention

The invention relates to a bus bar module and a wire harness.

### Description of Related Art

As a battery mounted on a hybrid motor vehicle or an electric vehicle, a battery module is known. The battery module is formed in such a way that a plurality of battery cells are laminated in a direction of thickness and the laminated battery cells are accommodated in a case. As the battery cell, for instance, a lithium ion battery or a secondary battery is used. In the battery module, bus bars which electrically connect electrode terminals of the individual battery cells together or voltage detection wires which detect the states of voltages of the individual battery cells are provided.

In order to achieve an electric connection to such a battery module, a bus bar module is proposed (see patent document 1: JP-A-2016-24933) in which bus bars or voltage detection wires are integrally formed. In the bus bar module, a cable part having a plurality of conductor wires is provided in one side and a flat plate conductor is provided in the other side.

[Patent Document 1] JP-A-2016-24933

According to a related art, in a bus bar module, since a cable part provided with a plurality of conductor wires and a flat plate conductor formed as a bus bar are molded integrally, a molding speed is low. Accordingly, it is to be said that productivity is not necessarily high.

Thus, the applicant of this application studies a use of a flat cable provided with an insulator resin part which fixes a bus bar. Namely, the applicant of this application studies that, for instance, the insulator resin part made of a resin is formed in place of the flat plate conductor of the bus bar module disclosed in a related art, and the bus bar is crimped and fixed to the insulator resin part in a subsequent process to form a bus bar module.

However, in such a bus bar module, when the insulator resin part is thinned, a holding power is weak when the bus bar is crimped and connected. Thus, when an impact is applied, the insulator resin part may be possibly broken to detach the bus bar from the insulator resin part.

### SUMMARY

One or more embodiments provide a bus bar module which can ensure a holding strength of an insulator resin part and a bus bar and a wire harness.

In an aspect (1), a bus bar module includes a flat cable having a cable part and an insulator resin part, and a bus bar crimped and fixed to the insulator resin part. The cable part includes a plurality of conductor wires arranged in parallel at predetermined intervals on a plane and a covering part integrally covering the plurality of conductor wires with an insulating resin. The insulator resin part is disposed in parallel to the cable part on the plane and made of a same resin as the insulating resin of the covering part. When a length in a direction intersecting at a right angle to the plane is defined as a thickness, the thickness of the insulator resin part is equal to or more than 0.5 mm, and a value obtained by dividing the thickness of the insulator resin part by a thickness of the bus bar is equal to or more than 0.5 and equal to or less than 2.38.

According to the aspect (1), the thickness of the insulator resin part is equal to or more than 0.5 mm, and the value obtained by dividing the thickness of the insulator resin part by the thickness of the bus bar is equal to or more than 0.5 and equal to or less than 2.38. When the thickness of the insulator resin part is smaller than 0.5 mm, a holding power cannot achieve a desired value (for instance, 50N). Accordingly, when the thickness of the insulator resin part is equal to or more than 0.5 mm, the desired value of the holding power can be easily achieved. Further, when the value obtained by dividing the thickness of the insulator resin part by the thickness of the bus bar is smaller than 0.5, the insulator resin part is too thin to the bus bar, so that the desired value of the holding power may not be possibly maintained. In addition thereto, when the above-described value exceeds 2.38, the insulator resin part is too thick to the bus bar and a crimping work is difficult so that the crimping work may be incomplete and the desired value of the holding power may not be probably maintained. Accordingly, when the above-described value is equal to or more than 0.5 and equal to or less than 2.38, the desired value of the holding power can be easily maintained. Thus, the bus bar module can be provided in which a holding strength of the insulator resin part and the bus bar can the ensured.

In an aspect (2), a sectional area of the insulator resin part is preferably equal to or less than 9.5 mm².

According to the aspect (2), when the sectional area of the insulator resin part is large, the insulator resin part sags due to its deadweight relative to the plane on which the conductor wires of the cable part are respectively arranged, so that an attaching property is deteriorated when the bus bar is fixed to the battery pack. Thus, when the sectional area of the insulator resin part is 9.5 mm² or smaller, a quantity of sagging can be 4 mm or smaller, so that an extreme deterioration of the attaching property can be prevented.

In an aspect (3), the thickness of the bus bar is preferably equal to or more than 0.8 mm and equal to or less than 1.5 mm.

According to the aspect (3), when the thickness of the bus bar is smaller than 0.8 mm, a workability of the bus bar is deteriorated. Further, when the thickness of the bus bar exceeds 1.5 mm, a management of the bus bar in a space in which the bus bar is mounted is deteriorated. Thus, when the thickness of the bus bar is equal to or more than 0.8 mm and equal to or less than 1.5 mm, the deterioration of workability of the bus bar can be suppressed and the deterioration of management of the bus bar in the space where the bus bar is mounted can be suppressed.

In an aspect (4), a wire harness is characterized in that the wire harness includes the bus bar module according to any one of the above-described bus bar modules.

According to the aspect (4), the wire harness having the bus bar module in which the holding strength of the insulator resin part and the bus bar is maintained can be provided.

According to one or more embodiments, a bus bar module in which a holding strength of an insulator resin part and a bus bar can be maintained, and a wire harness can be provided.

### BRIEF DESCRIPTION OF THE DRAWINGS

FIG. 1 is a perspective view of an upper surface of a wire harness including a bus bar module according to an exemplary embodiment.

FIG. 2 is a perspective view of a lower surface of the wire harness including the bus bar module according to the exemplary embodiment.

FIG. 3 is an exploded perspective view of the bus bar module shown in FIG. 1 and FIG. 2.

FIG. 4 is a sectional view of a flat cable shown in FIG. 1 to FIG. 3.

FIG. 5 is a sectional view of the bus bar module according to the present exemplary embodiment.

FIG. 6 is a table showing examples.

FIG. 7 is a table showing comparative examples.

### DETAILED DESCRIPTION

Now, the present invention will be described below by referring to a preferred exemplary embodiment. The present invention is not limited to a below-described exemplary embodiment and may be suitably changed within a scope which does not depart from the gist of the present invention. Further, in the below-described exemplary embodiment, an illustration or an explanation of a structure is partly omitted. However, it is to be understood that to a detail of the omitted technique, a well-known or conventional technique is applied within a range in which a contradiction to below-described contents does not occur.

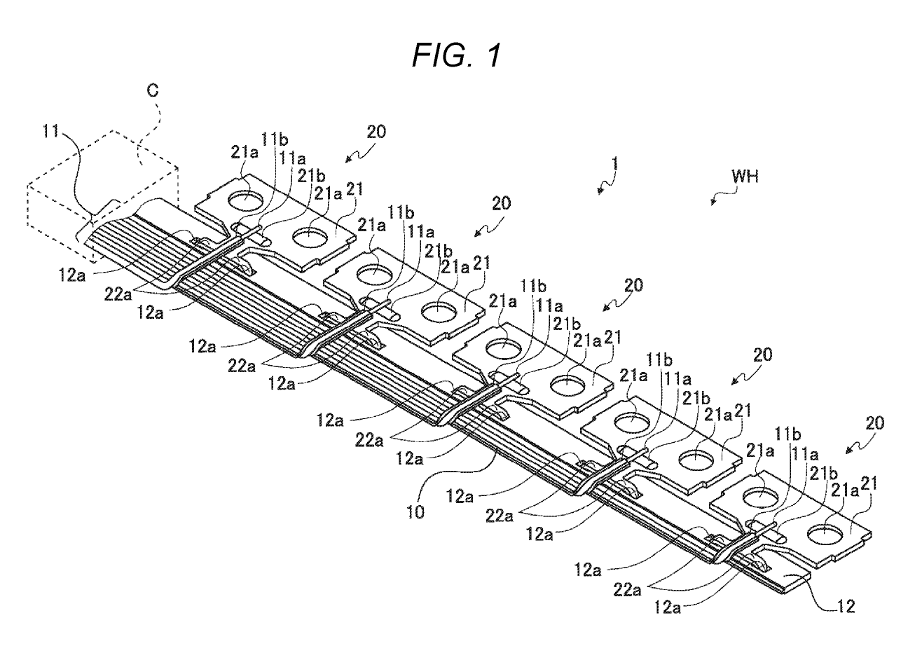

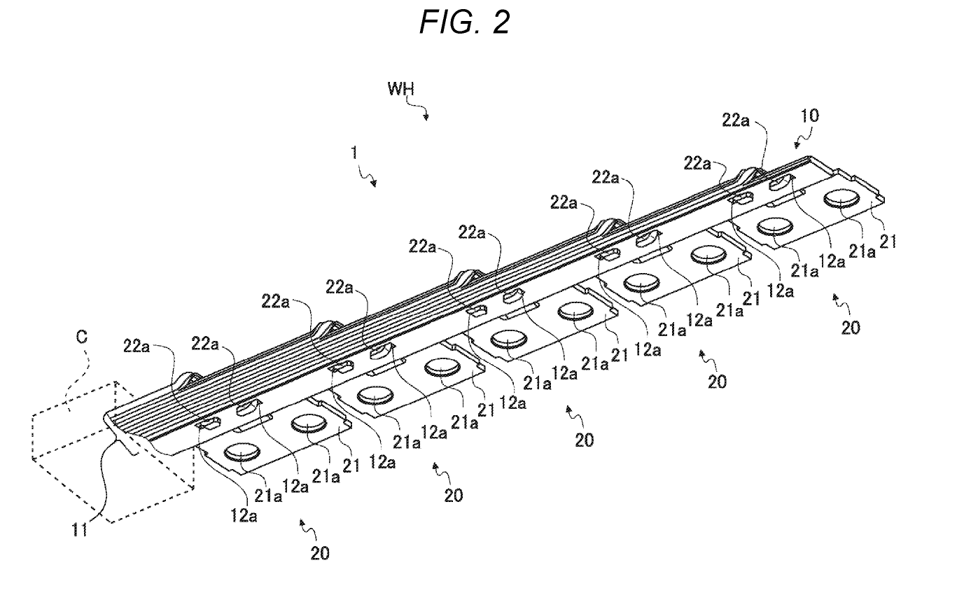

FIG. 1 is a perspective view of an upper surface of a wire harness including a bus bar module according to an exemplary embodiment of the present invention. FIG. 2 is a perspective view of a lower surface of the wire harness including the bus bar module according to the exemplary embodiment of the present invention. As shown in FIG. 1 and FIG. 2, the wire harness WH includes the bus bar module 1 and a connector C.

The bus bar module 1 includes a flat cable 10 and a plurality of bus bars 20. The connector C is provided in an end part of the flat cable 10 and connected to a connector of a monitor device side which monitors a battery voltage. The flat cable 10 has a plurality of conductor wires (below-described symbol 11a) and a specific conductor wire is connected to a specific bus bar 20.

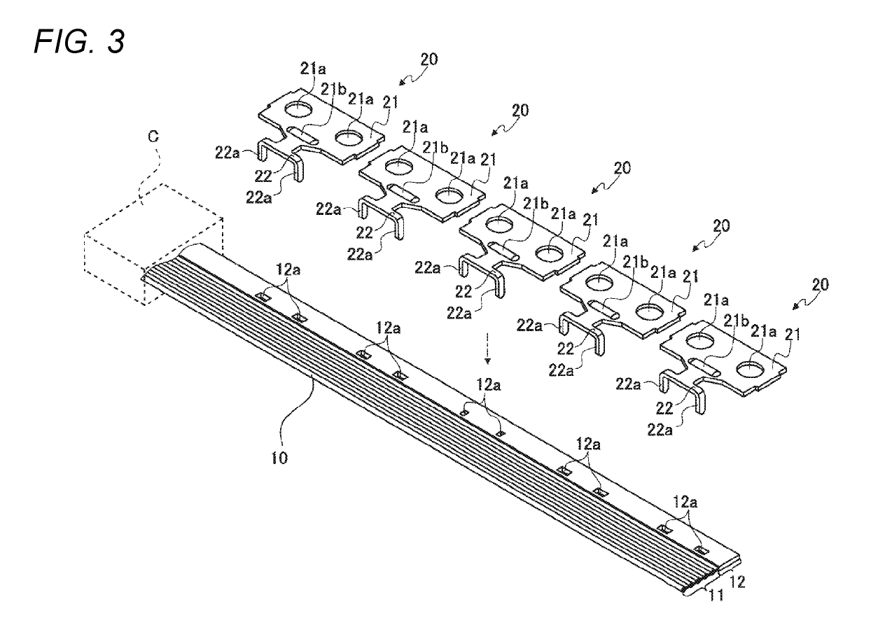

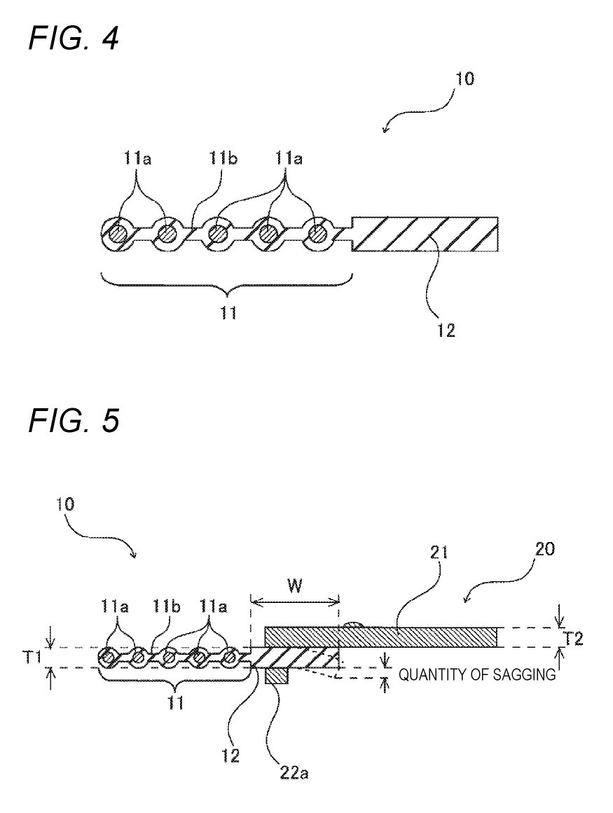

FIG. 3 is an exploded perspective view of the bus bar module 1 shown in FIG. 1 and FIG. 2. FIG. 4 is a sectional view of the flat cable 10 shown in FIG. 1 to FIG. 3. As shown in FIG. 1 to FIG. 4, the flat cable 10 includes a cable part 11 and an insulator rein part 12. The cable part 11 includes a plurality of conductor wires 11a and a covering part 11b.

The plurality of conductor wires 11a are formed with twisted wires of copper conductor having a sectional area of, for instance, 0.35 sq and arranged in parallel at predetermined intervals on a plane. The plurality of conductor wires 11a serve as, what is called voltage detection wires. The conductor wires 11a may be made of aluminum or alloy of copper or aluminum. The covering part 11b serves to coat together the plurality of conductor wires 11a arranged in parallel to an insulating resin. In the present exemplary embodiment, the insulating resin is, for instance, a polyvinyl chloride resin. However, the preset invention is not limited thereto.

The insulator resin part 12 is made of only an insulating resin. In the present exemplary embodiment, the insulator resin part 12 is made of the same resin as the insulating resin which forms the covering part 11b. The insulator resin part 12 is provided in parallel to the plurality of conductor wires 11a on the plane on which the plurality of conductor wires 11a are arranged in parallel. On the insulator resin part 12, two connection holes 12a are formed at intervals of predetermined distances. As shown in FIG. 1 to FIG. 3, the bus bars 20 are crimped and fixed through the two connection holes 12a. Further, the plurality of conductor wires 11a are respectively torn in a longitudinal direction and each of them is connected to the specific bus bar 20 by welding or the like.

As shown in FIG. 1 to FIG. 3, the bus bar 20 includes a flat plate shaped bus bar main body 21 made of an electrically conductive material and a crimping part 22 provided in one side (the flat cable 10 side) of the bus bar main body 21.

In the bus bar main body 21, two through holes 21a are formed. To the two through holes 21a, a positive terminal and a negative terminal of a battery side are respectively inserted and fastened by bolts. Further, in the bus bar main body 21, a connection part 21b of the conductor wire 11a is formed. The conductor wire 11a is connected to the connection part 21b by welding or the like.

The crimping part 22 includes a pair of crimping pieces 22a. The one pair of crimping pieces 22a are inserted into the two connection holes 12a, and then crimped (bent). The one pair of crimping pieces 22a are bent and crimped toward a direction in which the crimping pieces 22a come close to each other. However, the crimping direction is not limited thereto. For the crimping pieces 22, the number thereof is not one pair (two) and may be one or three or more. The form and structure thereof are not limited to those shown in FIG. 1 to FIG. 3. Additionally, when tip ends f the crimping pieces 22a are formed to be sharp, the connection holes 12a may not need to be formed in the insulator resin part 12.

In such a bus bar module 1, when the insulator resin part 12 is thinned, a holding power (a holding power of the bus bar 20 to the insulator resin part 12) is weak when the bus bar 20 is crimped and connected. Thus, when an impact is applied, the insulator resin part 12 may be possibly broken to detach the bus bar 20 from the insulator resin part.

Thus, the bus bar module 1 according to the present exemplary embodiment has a below-described structure. FIG. 5 is a sectional view of the bus bar module 1 according to the present exemplary embodiment. Initially, in the present exemplary embodiment, a thickness T1 of the insulator resin part 12 is equal to or more than 0.5 mm. When the thickness T1 of the insulator resin part 12 is smaller than 0.5 mm, since the insulator resin part 12 is too thin, the holding power cannot achieve a desired value (for instance, 50N).

Further, in the present exemplary embodiment, a value obtained by dividing the thickness T1 of the insulator resin part 12 by the thickness T2 of the bus bar 20 is equal to or more than 0.5 and equal to or less than 2.38. When the value obtained by dividing the thickness T1 of the insulator resin part 12 by the thickness T2 of the bus bar 20 is smaller than 0.5, the insulator resin part 12 is too thin to the bus bar 20, so that the desired value of the holding power may not be possibly maintained. In addition thereto, when the above-described value exceeds 2.38, the insulator resin part 12 is too thick to the bus bar 20 and a crimping work is difficult so that the crimping work may be incomplete and the desired value of the holding power may not be probably maintained.

Accordingly, in the present exemplary embodiment, the thickness T1 of the insulator resin part 12 is equal to or more than 0.5 mm. The value obtained by dividing the thickness T1 of the insulator resin part 12 by the thickness T2 of the bus bar 20 is equal to or more than 0.5 and equal to or less than 2.38.

A width W of the insulator resin part 12 is preferably 5.0 mm or larger. When the width W is too small, a connection working property to the bus bar 20 is deteriorated.

Further, in the present exemplary embodiment, a sectional area (a sectional area on a plane intersecting at right angles to a longitudinal direction of the flat cable 10) of the insulator resin part 12 is preferably equal to or less than 9.5 mm². The inventor of the present invention noticed that when the sectional area of the insulator resin part 12 is large, the insulator resin part 12 sags due to its dead weight relative to the plane on which the conductor wires 11a of the cable part 11 are respectively arranged. Thus, the bus bar 20 is crimped and fixed thereto under a state that the insulator resin part 12 sags, so that an attaching property is deteriorated when the bus bar 20 is fixed to the battery pack. Thus, when the sectional area of the insulator resin part 12 is 9.5 mm² or smaller, a quantity of sagging can be 4 mm or smaller than 4 mm. When the quantity of sagging is located within the above-described range, an extreme deterioration of the attaching property can be prevented.

Additionally, in the present exemplary embodiment, the thickness T2 of the bus bar 20 is preferably equal to or more than 0.8 mm and equal to or less than 1.5 mm. Here, the inventor of the present invention noticed that when the thickness T2 of the bus bar 20 is smaller than 0.8 mm, a workability of the bus bar 20 is deteriorated. Further, the inventor noticed that when the thickness T2 of the bus bar 20 exceeds 1.5 mm, a management of the bus bar 20 in a space in which the bus bar 20 is mounted is deteriorated. Thus, when the thickness T2 of the bus bar 20 is equal to or more than 0.8 mm and equal to or less than 1.5 mm, the deterioration of workability of the bus bar 20 can be suppressed and the deterioration of management of the bus bar 20 in the space where the bus bar 20 is mounted can be suppressed.

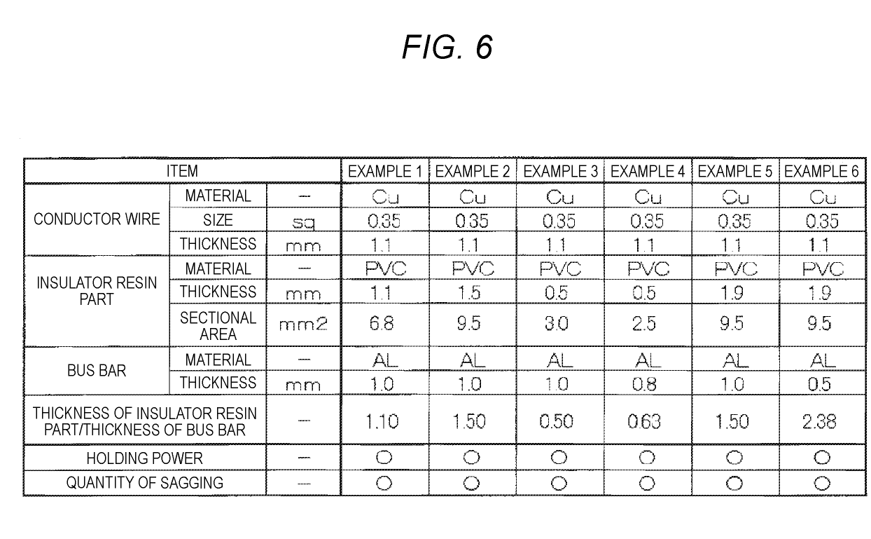

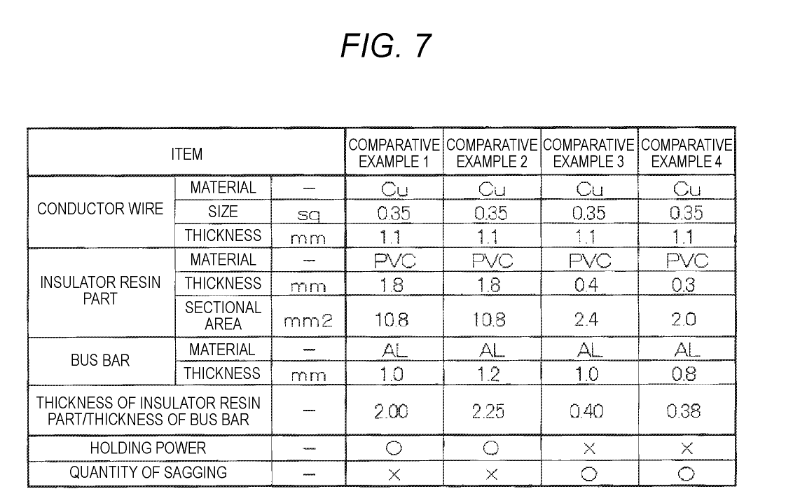

Now, examples and comparative examples of the present invention will be described below. FIG. 6 is a table showing the example and FIG. 7 is a table showing the comparative examples.

Initially, in the examples 1 to 6 and the comparative examples 1 to 4, the plurality of conductor wires are twisted wires made of copper having a sectional area of 0.35 sq (a thickness of 1.1 mm). Further, in the examples 1 to 6 and the comparative examples 1 to 4, the insulator resin part is made of polyvinyl chloride. The bus bar is made of aluminum.

The thickness of the insulator resin part is 1.1 mm, 1.5 mm, 0.5 mm, 0.5 mm, 1.9 mm, 1.9 mm, 1.8 mm, 1.8 mm, 0.4 mm and 0.3 mm in order of the examples 1 to 6 and the comparative examples 1 to 4. The sectional area of the insulator resin part is 6.8 mm², 9.5 mm², 3.0 mm², 2.5 mm², 9.5 mm², 9.5 mm², 10.8 mm², 10.8 mm², 2.4 mm² and 2.0 mm² in order of the examples 1 to 6 and the comparative examples 1 to 4.

The thickness of the bus bar is 1.0 mm, 1.0 mm, 1.0 mm, 0.8 mm, 1.0 mm, 0.5 mm, 1.0 mm, 1.2 mm, 1.0 mm and 0.8 mm in order of the examples 1 to 6 and the comparative examples 1 to 4.

From the thickness of the insulator resin part and the thickness of the bus bar, the value obtained by dividing the former by the latter is 1.10, 1.50, 0.50, 0.63, 1.50, 2.38, 2.00, 2.25, 0.40 and 0.38 in order of the exampled 1 to 6 and the comparative examples 1 to 4.

For the examples 1 to 6 and the comparative examples 1 to 4, the holding power and the quantity of sagging are measured. As for the holding power, after the bus bar is crimped to the insulator resin part, the insulator resin part is pulled at a speed of 100 mm/min under a state that the bus bar is fixed, a maximum value of the power is measured until a slip or a backlash occurs in a pulling direction. In FIG. 6, when the holding power is 50N or larger then 50N, “O” is given and when the holding power is smaller than 50N, “X” is given.

As for the quantity of sagging, the plane on which the plurality of conductor wires is arranged is made to correspond to a horizontal plane. A distance that an end part (an end part of a bus bar side) of the insulator resin part sags downward in a vertical direction is measured. In FIG. 6, when the quantity of sagging is 4 mm or smaller, “O” is given. When the quantity of sagging exceeds 4 mm, “X” is given.

As apparent from the examples 1 to 6 and the comparative examples 1 to 4, in the comparative examples 3 and 4 which do not satisfy conditions that the thickness of the insulator resin part is equal to or more than 0.5 mm and the value obtained by dividing the thickness of the insulator resin part by the thickness of the bus bar is equal to or more than 0.5 and 2.38 and smaller than 2.38. “X” is given to the holding power. As compared therewith, in the examples 1 to 6 and the comparative examples 1 and 2 which satisfy the conditions that the thickness of the insulator resin part is equal to or more than 0.5 mm and the value obtained by dividing the thickness of the insulator resin part by the thickness of the bus bar is equal to or more than 0.5 and 2.38 and smaller than 2.38. “O” is given to the holding power.

Further, in the comparative examples 1 and 2 which do not satisfy a condition that the sectional area of the insulator resin part is 9.5 mm² or smaller than 9.5 mm², “X” is given to the quantity of sagging. As compared therewith, in the examples 1 to 6 and the comparative examples 3 and 4 which satisfy the condition that the sectional area of the insulator resin part is 9.5 mm² or smaller than 9.5 mm², “O” is given to the quantity of sagging.

As described above, according to the bus bar module 1 of the present exemplary embodiment, the thickness T1 of the insulator resin part 12 is equal to or more than 0.5 mm, and the value obtained by dividing the thickness T1 of the insulator resin part 12 by the thickness T2 of the bus bar 20 is equal to or more than 0.5 and equal to or less than 2.38. Here, the inventor of the present invention found that when the thickness T1 of the insulator resin part 12 is smaller than 0.5 mm, the holding power cannot achieve a desired value (for instance, 50N). Accordingly, when the thickness T1 of the insulator resin part 12 is equal to or more than 0.5 mm, the desired value of the holding power can be easily achieved. Further, the inventor of the present invention found that when the value obtained by dividing the thickness T1 of the insulator resin part 12 by the thickness T2 of the bus bar 20 is smaller than 0.5, the insulator resin part 12 is too thin to the bus bar 20, so that the desired value of the holding power may not be possibly maintained. In addition thereto, the inventor noticed that when the above-described value exceeds 2.38, the insulator resin part 12 is too thick to the bus bar 20 and a crimping work is difficult so that the crimping work may be incomplete and the desired value of the holding power may not be probably maintained. Accordingly, when the above-described value is equal to or more than 0.5 and equal to or less than 2.38, the desired value of the holding power can be easily maintained. Thus, the bus bar module 1 can be provided in which a holding strength of the insulator resin part 12 and the bus bar 20 can the ensured.

Further, the sectional area of the insulator resin part 12 is equal to or less than 9.5 mm². Here, the inventor of the present invention noticed that when the sectional area of the insulator resin part 12 is large, the insulator resin part 12 sags due to its dead weight relative to the plane on which the conductor wires 11a of the cable part 11 are respectively arranged, so that an attaching property is deteriorated when the bus bar 20 is fixed to the battery pack. Thus, when the sectional area of the insulator resin part 12 is 9.5 mm² or smaller, the quantity of sagging can be 4 mm or smaller, so that an extreme deterioration of the attaching property can be prevented.

Further, in the bus bar module, the thickness T2 of the bus bar 20 is equal to or more than 0.8 mm and equal to or less than 1.5 mm. Here, the inventor of the present invention noticed that when the thickness T2 of the bus bar 20 is smaller than 0.8 mm, a workability of the bus bar 20 is deteriorated. Further, the inventor noticed that when the thickness T2 of the bus bar 20 exceeds 1.5 mm, a management of the bus bar in a space in which the bus bar 20 is mounted is deteriorated. Thus, when the thickness T2 of the bus bar 20 is equal to or more than 0.8 mm and equal to or less than 1.5 mm, the deterioration of workability of the bus bar 20 can be suppressed and the deterioration of management of the bus bar in the space where the bus bar 20 is mounted can be suppressed.

Further, in the wire harness WH according to the present exemplary embodiment, the wire harness WH can be provided that has the bus bar module 1 in which the holding strength of the insulator resin part 12 and the bus bar 20 is ensured.

The present invention is described above by referring to the exemplary embodiment. However, the present invention is not limited to the above-described exemplary embodiment and may be changed within a range which does not deviate from the gist of the present invention and combined with a well-known and conventional technique.

For instance, in the present exemplary embodiment, the insulator resin part 12 has a rectangular form in section. However, the form of the insulator resin part 12 is not limited to the rectangular form and may have other forms such as an elliptic form or an oval form as long as the bus bar 20 can be fixed thereto. In this case, as the thickness T1 of the insulator resin part 12, a thickness is used in the vicinity of a part to which the bus bar 20 is crimped and fixed.

Further, in the flat cable 10, the conductor wires 11a respectively have the same size. However, the present invention is not limited thereto. The sizes of the conductor wires 11a may be partly different. Additionally, the insulating resin used in the covering part 11b and the insulator resin part 12 is not limited to polyvinyl chloride and other insulating resin may be used.

### DESCRIPTION OF REFERENCE NUMERALS AND SIGNS

1 . . . bus bar module
10 . . . flat cable
11 . . . cable part
11a . . . conductor wire
11b . . . covering part
12 . . . insulator resin part
12a . . . connection hole
20 . . . bus bar
21 . . . bus bar main body
21a . . . through hole
21b . . . connection part
22 . . . crimping part
22a . . . crimping piece
C . . . connector
WH . . . wire harness

What is claimed is:

1. A bus bar module comprising:
a flat cable having a cable part and an insulator resin part; and
a bus bar crimped and fixed to the insulator resin part,
wherein the cable part includes a plurality of conductor wires arranged in parallel at predetermined intervals on a plane and a covering part integrally covering the plurality of conductor wires with an insulating resin,
wherein the insulator resin part is disposed in parallel to the cable part on the plane and made of a same resin as the insulating resin of the covering part, and
wherein when a length in a direction intersecting at a right angle to the plane is defined as a thickness, the thickness of the insulator resin part is equal to or more than 0.5 mm, and a value obtained by dividing the thickness of the insulator resin part by a thickness of the bus bar is equal to or more than 0.5 and equal to or less than 2.38.

2. The bus bar module according to claim 1,
wherein a sectional area of the insulator resin part is equal to or less than 9.5 mm².

3. The bus bar module according to claim 1,
wherein the thickness of the bus bar is equal to or more than 0.8 mm and equal to or less than 1.5 mm.

4. A wire harness comprising the bus bar module according to claim 1.
